(19) United States
(12) Patent Application Publication
(10) Pub. No.: US 2008/0208768 A1
(43) Pub. Date: Aug. 28, 2008

(54) DERIVATIVE CONTRACT AND METHOD FOR CREATING SAME FROM A PREDEFINED PERCENTAGE OF AN UNDERLYING SECURITY

(76) Inventor: William Speth, Evanston, IL (US)

Correspondence Address: BRINKS HOFER GILSON & LIONE, P.O. BOX 10395, CHICAGO, IL, 60610, US

(21) Appl. No.: 12/030,701

(22) Filed: Feb. 13, 2008

Related U.S. Application Data
(60) Provisional application No. 60/901,842, filed on Feb. 14, 2007.

(51) Int. Cl. G06Q 40/00

(52) U.S. Cl. 705/36 R; 705/35; 705/37

(57) ABSTRACT

A derivative contract is disclosed including an option notional value of an underlying unit calculated from a predefined percentage of an underlying security according to the formula:

U_{U}=X_{%}(U_{S}*U_{OD})

wherein U_{U} is the option notional value of the underlying unit, X_{%} is the predefined percentage, U_{S} is the price of the underlying security and U_{OD} is a number of units per option deliverable.

### CROSS-REFERENCE TO RELATED APPLICATIONS

This application claims the benefit of U.S. Provisional Application No. 60/901,842, pending, filed Feb. 14, 2007, the entirety of which is incorporated by reference herein.

### TECHNICAL FIELD

The present disclosure relates to the trading of securities or derivatives, such as options or futures. More particularly, the present disclosure relates to a derivative contract and method for creating same that is calculated from a predefined percentage of an underlying security.

### BACKGROUND

There are several known investment trusts that hold a stock portfolio of a particular industry, sector or group designed to provide a diversified exposure to the industry, sector or a group. For example, Merrill Lynch provides Holding Company Depositary Receipts®, or HOLDRs®, that are trust-issued receipts representing a beneficial ownership of a specified group of stocks. The owner of a particular HOLDR® owns a group of stocks as one asset, but can also unbundle the HOLDR® any time to own each of the underlying stocks. The unbundled stocks can be traded individually to meet specific tax or investment goals. HOLDRs® are taxed only on gains and income that the owner actually realizes. Thus, HOLDRs® allow the owner to take tax losses in any individual stock that declines and allow the owner to defer capital gains indefinitely on the best performing stocks. Furthermore, HOLDRs® have a buy-and-hold feature that limits taxes resulting from portfolio turnover.

The individual HOLDRs® are exchange-traded and are priced just like any other stock to provide liquidity. The owner retains the voting and dividend rights on the underlying stocks. HOLDRs® provide a relatively inexpensive way to own about 19 to 20 stocks. The owner does not pay management fees, but pays transaction costs and an annual custody fee taken against cash dividends and distributions, when they are issued.

Each of the existing “holds” provides a relatively limited diversification and does not enable systematic investment in micro cap, small cap, mid cap and large cap stocks across the entire market.

A HOLDR® functions similarly to a stock, but with some differences. Like stocks, a HOLDR® can be bought on margin or shorted. However, unlike stocks, investors can only buy round lots (multiples of 100 shares) of HOLDR® securities. Therefore, buying into a HOLDR® can be expensive for an investor. Thus, a need exists for a financial product, such as an option, which is based on a percentage of a single, high-priced security so as to trade smaller versions thereof.

Accordingly, there is a need for a financial product and a method for creating a financial product that can address the drawbacks of the prior art financial products.

### BRIEF SUMMARY

In order to address the need for improvements on financial products, a derivative contract and method is disclosed herein that is calculated from a predefined percentage of an underlying security.

According to a first aspect of the disclosure, a derivative contract is disclosed including an option notional value of an underlying unit calculated from a predefined percentage of an underlying security according to the formula:

U_{U}=X_{%}(U_{S}*U_{OD})

wherein U_{U} is the option notional value of the underlying unit, X_{%} is the predefined percentage, U_{S} is the price of the underlying security and U_{OD} is a number of units per option deliverable.

In another aspect of the disclosure, a computer-readable memory is disclosed that contains processor executable program instructions for creating a derivative contract. The instructions include instructions for causing a processor to calculate an option notional value of an underlying unit from a predefined percentage of an underlying security according to the formula:

U_{U}=X_{%}(U_{S}*U_{OD})

where U_{U} is the option notional value of the underlying unit, X_{%} is the predefined percentage, U_{S} is the price of the underlying unit and U_{OD} is a number of units per option deliverable. The computer-readable memory may further include processor executable program instructions for creating a derivative contract based on the calculated option notional value.

In yet another aspect, a method for creating a derivative contract is disclosed. The method includes calculating an option notional value of an underlying unit from a predefined percentage of an underlying security according to the formula:

U_{U}=X_{%}(U_{S}*U_{OD})

U_{U} is the option notional value of the underlying unit, X_{%} is the predefined percentage, U_{S} is the price of the underlying unit and U_{OD} is a number of units per option deliverable. The method also includes displaying the calculated option notional value and creating a derivative contract based on the option notional value.

A more detailed explanation of the invention is provided in the following description and examples.

### BRIEF DESCRIPTION OF THE DRAWINGS

FIG. 1 is a flow-chart diagram of one method of creating a derivative from a predefined percentage of an underlying security.

FIG. 2 is a block diagram of a general computing device and network connectivity.

### DETAILED DESCRIPTION

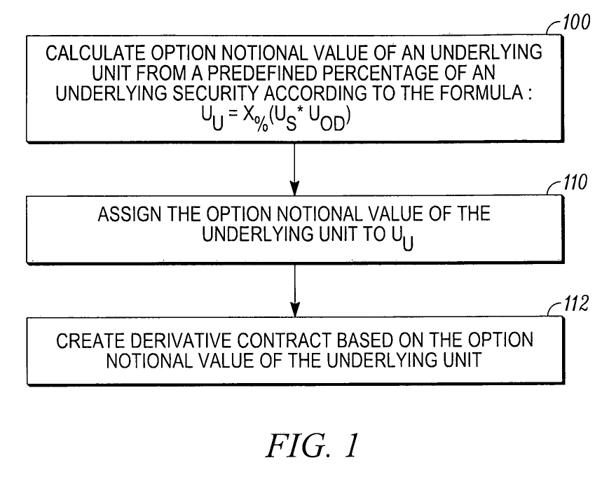

Referring to FIG. 1 and the exemplary embodiments provided herein below, a derivative contract can be created based on an option notional value of an underlying unit calculated (at step 100) from a predefined percentage of an underlying security according to the formula:

U_{U}=X_{%}(U_{S}*U_{OD})

Correspondingly, at step 110 of FIG. 1, U_{U} is assigned the option notional value of the underlying unit, where X_{%} is the predefined percentage, U_{S} is the price of the underlying unit and U_{OD} is a number of units per option deliverable. Preferably, the predefined percentage (X_{%}) is user-definable and not static, thereby providing a degree of flexibility in the calculation of the option notional value of the underlying unit (U_{U}) and the creation of the derivative contract (at step 112). Thus, both “micro” and “macro”-share derivative contracts can be calculated based on an underlying unit as described with reference to Examples 1 and 2 disclosed herein.

In one embodiment, a derivative contract, such as a “micro-share” options contract, is based on a hypothetical holding of 100 “micro-shares” of a single security. A “micro-share” is defined as 1/10^{th} of a whole share, such that when exercised, each micro-share option requires the receipt or delivery of 10 shares of the underlying security. Premiums for micro-share options are preferably quoted on a “per micro-share” basis; that is, using a value, preferably calculated by an exchange, equal to 1/10^{th} the price of the underlying security.

Micro-shares are not listed securities. As a result, micro-share options would be treated as “micro” narrow-based index options, and would be physically settled contracts. Generally, an index is narrow-based only if it contains nine or fewer component securities, if a single component security comprises more than 30% of its weighting, or if the aggregate of the five highest-weighted component securities comprise more than 60% of its weighting.

### EXAMPLE 1

### Micro-Share Options

The following Table 1 illustrates a comparison between standard Google® options and Google® micro-share options:

TABLE 1

| | | Google ® |
|---|---|---|
| Underlying | Google ® | “micro-shares” |
| Underlying Unit | 1 share | 1 micro-share |
| Price per Underlying Unit | $350 | $35 |
| Units per Option Deliverable | 100 | 100 |
| Option Notional Value (price × | $35,000 | $3,500 |
| deliverable) | | |
| Whole Share equivalent of | 100 | 10 |
| option deliverable | | |
| Hypothetical Option Premium | $21.50 | $2.15 |
| Minimum Tick Size/Value per | 0.05 pts/$5.00 | 0.05 pts/$5.00 |
| Tick | | |

As illustrated in Table 1, the underlying unit of Google® is one share, and the Google® “micro-share” is one micro-share. Since a “micro-share” is defined as 1/10^{th} of a whole share, the price per underlying unit of the Google® “micro-share” ($35) is 1/10^{th} of the price per underlying unit of the Google® share ($350). Likewise, the differences in the option notional value and whole share equivalent of option deliverable between a Google® share and a Google® micro-share are tenfold, such that the option notional value of a Google® micro-share is 1/10^{th} of the option notional value of a Google® share and the whole share equivalent of option deliverable of a Google® micro-share is 1/10^{th} of the whole share equivalent of option deliverable of a Google® share. Thus, as illustrated, it is preferred that the hypothetical option premium of a Google® micro-share is 1/10^{th} of the option notional value of a Google® share.

It is preferred that micro-share options aggregate with whole share options of the same underlying for position limit purposes.

In another embodiment, an extension of the micro-share option concept is “macro-share” options, based on a holding of 100 “macro-shares” that are equivalent to 10 whole shares of a single security. “Mega-share” options would be used to trade low-priced securities, such as presently-priced Lucent Technologies and Sun Microsystems.

As such, a “macro-share” options contract is based on a hypothetical holding of 100 “macro-shares” of a single security. A “macro-share” is defined as 10 times a whole share, such that when exercised, each macro-share option requires the receipt or delivery of 10 shares of the underlying security. Premiums for macro-share options are preferably quoted on a “per macro-share” basis; that is, using a value, preferably calculated by an exchange, equal to 10 times the price of the underlying security.

Macro-shares are also not listed securities. As a result, macro-share options would also be treated as “macro” narrow-based index options, and would likewise be physically settled contracts.

### EXAMPLE 2

### Macro-Share Options

The following Table 2 illustrates a comparison between standard Lucent Technologies® options and Lucent Technologies® macro-share options:

TABLE 2

| | | Lucent |
|---|---|---|
| | Lucent | Technologies ® |
| Underlying | Technologies ® | “macro-shares” |
| Underlying Unit | 1 share | 1 macro-share |
| Price per Underlying Unit | $2.5 | $25 |
| Units per Option Deliverable | 100 | 100 |
| Option Notional Value (price × | $250 | $2,500 |
| deliverable) | | |
| Whole Share equivalent of | 10 | 100 |
| option deliverable | | |
| Hypothetical Option Premium | $0.15 | $1.50 |
| Minimum Tick Size/Value per | 0.05 pts/$5.00 | 0.05 pts/$5.00 |
| Tick | | |

As illustrated in Table 2, the underlying unit of Lucent Technologies® is one share, and the Lucent Technologies “macro-share” is one macro-share. Since a “macro-share” is defined as 10 times a whole share, the price per underlying unit of the Lucent Technologies® “macro-share” ($25) is 10 times the price per underlying unit of the Lucent Technologies® share ($2.5). Likewise, the differences in the option notional value and whole share equivalent of option deliverable between a Lucent Technologies® share and a Lucent Technologies® macro-share are tenfold, such that the option notional value of a Lucent Technologies® macro-share is 10 times the option notional value of a Lucent Technologies® share and the whole share equivalent of option deliverable of a Lucent Technologies macro-share is 10 times the whole share equivalent of option deliverable of a Lucent Technologies® share. Thus, as illustrated, it is preferred that the hypothetical option premium of a Lucent Technologies® macro-share is 10 times the option notional value of a Lucent Technologies share.

It is further preferred that macro-share options aggregate with whole share options of the same underlying for position limit purposes.

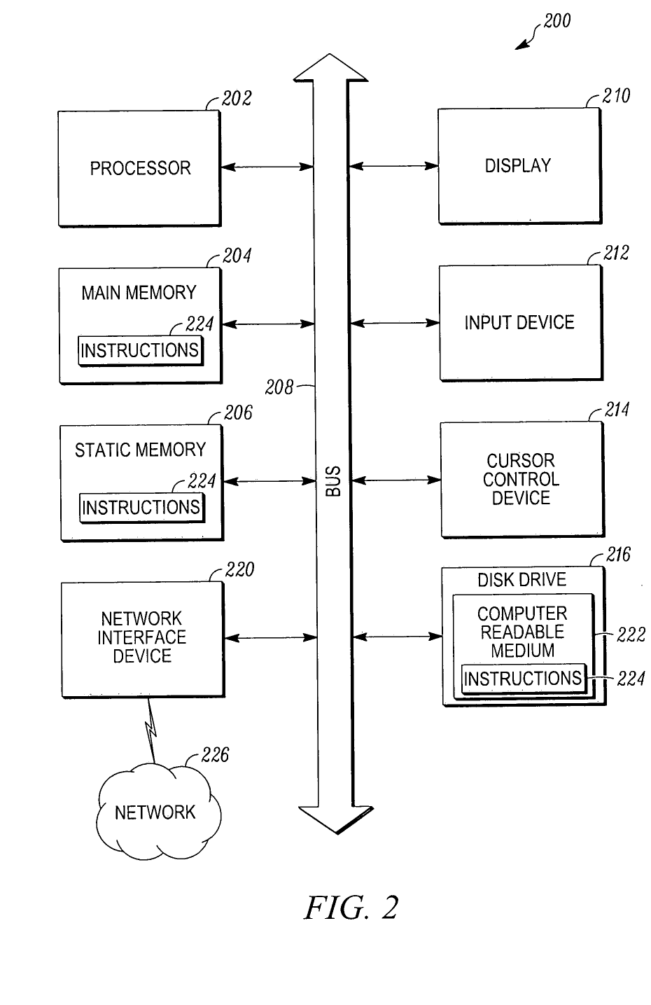

Referring now to FIG. 2, an illustrative embodiment of a general computer system that may be used for one or more of the steps shown in FIG. 1, or in any other trading system configured to carry out the methods discussed above, is shown and is designated 200. The computer system 200 can include a set of instructions that can be executed to cause the computer system 200 to perform any one or more of the methods or computer based functions disclosed herein. The computer system 200 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 200 can be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. Moreover, the computer system 200 can include a main memory 204 and a static memory 206 that can communicate with each other via a bus 208. As shown, the computer system 200 may further include a video display unit 210, such as a liquid crystal display (LCD), an organic light emitting diode (OLED), a flat panel display, a solid state display, or a cathode ray tube (CRT). Additionally, the computer system 200 may include an input device 212, such as a keyboard, and a cursor control device 214, such as a mouse. The computer system 200 can also include a disk drive unit 216 and a network interface device 220.

In a particular embodiment, as depicted in FIG. 2, the disk drive unit 216 may include a computer-readable medium 222 in which one or more sets of instructions 224, e.g. software, can be embedded. Further, the instructions 224 may embody one or more of the methods or logic as described herein. In a particular embodiment, the instructions 224 may reside completely, or at least partially, within the main memory 204, the static memory 206, and/or within the processor 202 during execution by the computer system 200. The main memory 204 and the processor 202 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 224 or receives and executes instructions 224 responsive to a propagated signal, so that a device connected to a network 226 can communicate voice, video or data over the network 226. Further, the instructions 224 may be transmitted or received over the network 226 via the network interface device 220.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used on financial exchanges, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

As has been described above, the “micro” and “macro”-share derivative contracts offer market participants the ability to trade with greater flexibility and ease.

The matter set forth in the foregoing description is offered by way of illustration only and not as a limitation. While particular embodiments have been described, it will be apparent to those skilled in the art that changes and modifications may be made without departing from the broader aspects of applicants' contribution. It is therefore intended that the foregoing detailed description be regarded as illustrative rather than limiting, and that it be understood that it is the following claims, including all equivalents, that are intended to define the scope of this invention.

What is claimed is:

1. A derivative contract comprising:
an option notional value of an underlying unit calculated from a predefined percentage of an underlying security according to the formula:
U_{U}=X_{%}(U_{S}*U_{OD})
wherein U_{U} is the option notional value of the underlying unit, X_{%} is the predefined percentage, U_{S} is the price of the underlying unit and U_{OD} is a number of units per option deliverable.

2. The derivative contract according to claim 1 wherein the predefined percentage (X_{%}) is user-definable.

3. The derivative contract according to claim 1 wherein the derivative contract is a micro-share options contract.

4. The derivative contract according to claim 3 wherein the micro-share options contract requires receipt or delivery of shares of the underlying security when exercised.

5. The derivative contract according to claim 1 wherein the derivative contract is a macro-share options contract.

6. The derivative contract according to claim 5 wherein the macro-share option contract requires the receipt or delivery of shares of the underlying security when exercised.

7. A computer-readable memory containing processor executable program instructions for creating a derivative contract according to the following steps:
calculating an option notional value of an underlying unit from a predefined percentage of an underlying security according to the formula:
U_{U}=X_{%}(U_{S}*U_{OD})
wherein U_{U} is the option notional value of the underlying unit, X_{%} is the predefined percentage, U_{S} is the price of the underlying unit and U_{OD} is a number of units per option deliverable.

8. The computer-readable memory containing processor executable program instructions according to claim 7 further comprising the step of creating a derivative contract based on the option notional value.

9. The computer-readable memory containing processor executable program instructions according to claim 7 wherein the predefined percentage (X_{%}) is user-definable.

10. The computer-readable memory containing processor executable program instructions according to claim 8 wherein the derivative contract is a micro-share options contract.

11. The computer-readable memory containing processor executable program instructions according to claim 10 wherein the micro-share options contract requires receipt or delivery of shares of the underlying security when exercised.

12. The computer-readable memory containing processor executable program instructions according to claim 8 wherein the derivative contract is a macro-share options contract.

13. The computer-readable memory containing processor executable program instructions according to claim 12 wherein the macro-share option contract requires the receipt or delivery of shares of the underlying security when exercised.

14. A method for creating a derivative contract, the method comprising:
calculating an option notional value of an underlying unit from a predefined percentage of an underlying security according to the formula:
U_{U}=X_{%}(U_{S}*U_{OD})
wherein U_{U} is the option notional value of the underlying unit, X_{%} is the predefined percentage, U_{S} is the price of the underlying unit and U_{OD} is a number of units per option deliverable;
displaying the calculated option notional value; and
creating a derivative contract based on the option notional value.

15. The method according to claim 14 further comprising receiving the predefined percentage (X_{%}) from a user.

16. The method according to claim 14 wherein creating the derivative contract comprises creating a micro-share options contract having a fractional value of an option for the underlying security.

17. The method according to claim 16 wherein creating the derivative contract comprises forming the micro-share options contract to require receipt or delivery of shares of the underlying security when exercised.

18. The method according to claim 14 wherein creating the derivative contract comprises creating a macro-share options contract having a greater value than an option for the underlying security.

19. The method according to claim 18 wherein the creating the derivative contract comprises forming the macro-share options contract to require receipt or delivery of shares of the underlying security when exercised.
